(19) United States
(12) Patent Application Publication
(10) Pub. No.: US 2014/0109397 A1
(43) Pub. Date: Apr. 24, 2014

(54) HEATED FOLDING OF SEALS IN BATTERY CELLS

(71) Applicant: APPLE INC., Cupertino, CA (US)

(72) Inventors: Sheba Devan, Santa Clara, CA (US); Ramesh C. Bhardwaj, Fremont, CA (US); Taisup Hwang, Santa Clara, CA (US); Richard M. Mank, Cupertino, CA (US)

(73) Assignee: APPLE INC., Cupertino, CA (US)

(21) Appl. No.: 13/753,349

(22) Filed: Jan. 29, 2013

Related U.S. Application Data
(60) Provisional application No. 61/717,004, filed on Oct. 22, 2012.

(51) Int. Cl. H01M 10/04

(52) U.S. Cl. CPC H01M 10/049
USPC 29/623.2

(57) ABSTRACT

The disclosed embodiments relate to the manufacture of a battery cell. The battery cell includes a set of layers including a cathode with an active coating, a separator, and an anode with an active coating. The battery cell also includes a pouch enclosing the layers, wherein the pouch is flexible. The layers may be wound to create a jelly roll and/or stacked prior to sealing the layers in the flexible pouch. A side fold is also formed in the pouch by producing a target temperature in the range of 55° C. to 75° C. at a side seal of the pouch prior to folding the side seal against the battery cell.

### RELATED APPLICATION

This application hereby claims priority under 35 U.S.C. §119 to U.S. Provisional Application No. 61/717,004, entitled “Heated Folding of Seals in Battery Cells,” by Sheba Devan, Ramesh C. Bhardwaj, Taisup Hwang and Richard M. Mank filed 22 Oct. 2012 (Atty. Docket No.: APL-P17636USP1).

### BACKGROUND

1. Field

The disclosed embodiments relate to batteries for portable electronic devices. More specifically, the disclosed embodiments relate to techniques for performing heated folding of seals in batteries for portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

Furthermore, a reduction in one or more battery dimensions may enable the creation of portable electronic devices with small, thin, portable, and/or aesthetically pleasing form factors. For example, an increase in the energy density of a battery may facilitate a decrease in the battery's thickness while maintaining the battery's capacity. In turn, the decreased thickness may allow for a corresponding decrease in the thickness of the portable electronic device powered by the battery and/or the freeing up of space within the portable electronic device to accommodate other components (e.g., display, processor, memory, etc.).

However, a decrease in battery thickness affects the width of battery pouch seals along the sides of the battery cells. These seals are typically folded up against the sides of a battery cell, so a decrease in cell thickness necessitates a decrease in the width of the seal. This decrease in the width of a battery pouch seal can possibly compromise the integrity of the seal, especially when the seal is subject to mechanical stresses during the folding process.

Consequently, what is needed is a method and an apparatus for ensuring that the integrity of a battery pouch seal is not compromised by mechanical stresses during the folding process.

### SUMMARY

The disclosed embodiments relate to the manufacture of a battery cell. The battery cell includes a set of layers including a cathode with an active coating, a separator, and an anode with an active coating. The battery cell also includes a pouch enclosing the layers, wherein the pouch is flexible. The layers may be wound to create a jelly roll and/or stacked prior to sealing the layers in the flexible pouch. A side fold is also formed in the pouch by producing a target temperature in the range of 55° C. to 75° C. at a side seal of the pouch prior to folding the side seal against the battery cell.

In some embodiments, the battery cell also includes a first conductive tab coupled to the cathode and a second conductive tab coupled to the anode. The first and second conductive tabs extend through the terrace seal to provide terminals for the battery cell.

In some embodiments, producing the temperature at the side seal during folding of the side seal against the battery cell involves at least one of:
(i) applying a first temperature of about 110° C. to 150° C. to a region of the side seal in the battery cell prior to folding the side seal; and
(ii) applying a second temperature of about 120° C. to 130° C. to the region during folding of the side seal.

In some embodiments, the first temperature is applied for 30 seconds to 90 seconds prior to folding the side seal.

In some embodiments, folding of the side seal against the battery cell involves progressively folding the side seal toward the battery cell to form the side fold, and pressing the side seal against the battery cell to set the side fold.

In some embodiments, the target temperature reduces stress on the seal during folding of the side seal against the battery cell.

In some embodiments, the pouch includes a layer of aluminum and a layer of polypropylene.

### BRIEF DESCRIPTION OF THE FIGURES

FIG. 1 shows the placement of a battery in a computer system in accordance with the disclosed embodiments.

FIG. 2 shows a top-down view of a battery cell in accordance with the disclosed embodiments.

FIG. 3 shows an exemplary formation of a set of side folds in a battery cell in accordance with the disclosed embodiments.

FIG. 4 shows an exemplary formation of a set of side folds in a battery cell in accordance with the disclosed embodiments.

FIG. 5 shows a flowchart illustrating the process of manufacturing a battery cell in accordance with the disclosed embodiments.

FIG. 6 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

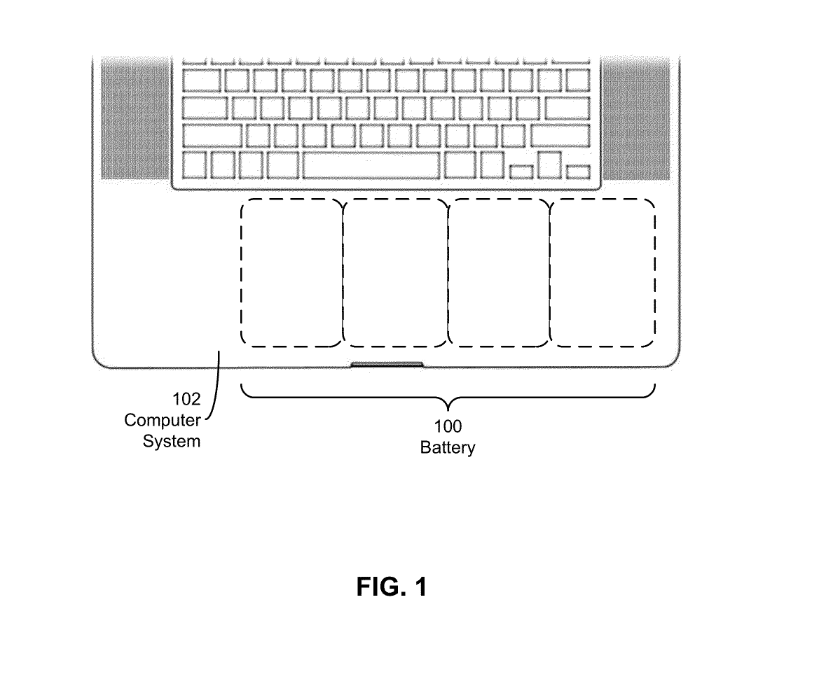

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of rechargeable power source for computer system 102. For example, battery 100 may include one or more lithium-polymer battery cells packaged in flexible pouches. The battery cells may then be connected in series and/or in parallel and used to power computer system 102.

In one or more embodiments, battery 100 is designed to accommodate the space constraints of computer system 102. For example, battery 100 may include battery cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

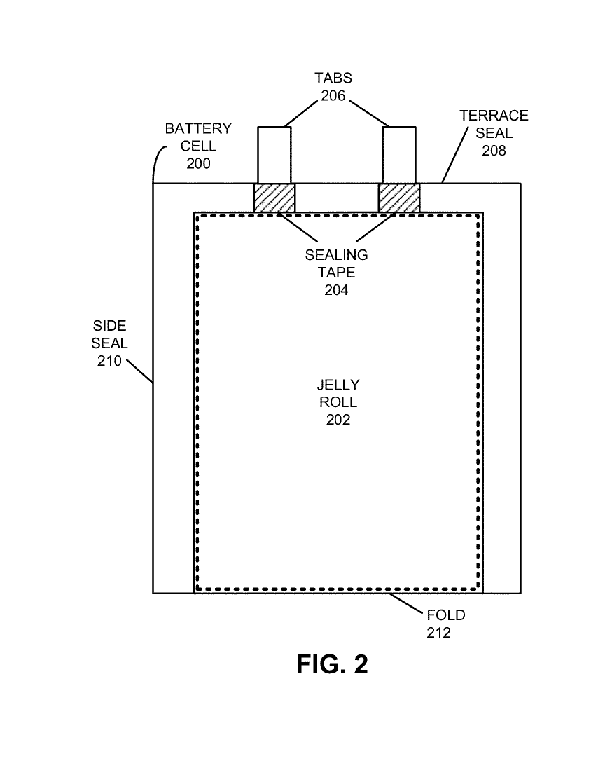

FIG. 2 shows a battery cell 200 in accordance with an embodiment. Battery cell 200 may correspond to a lithium-polymer cell that is used to power a portable electronic device. For example, battery cell 200 may be used in a battery pack that supplies power to components of a computer system, such as computer system 102 of FIG. 1. Battery cell 200 includes a jelly roll 202 containing a number of layers which are wound together, including a cathode with an active coating, a separator, and an anode with an active coating.

More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Alternatively, the layers may be used to form other types of battery cell structures. For example, the layers may be stacked to form bi-cell structures. Jelly rolls are well known in the art and will not be described further.

During assembly of battery cell 200, jelly roll 202 is enclosed in a flexible pouch, which is formed by folding a flexible sheet along a fold line 212. For example, the flexible sheet may be made of aluminum with a polymer film, such as polypropylene and/or polyethylene. After the flexible sheet is folded, the flexible sheet can be sealed, for example, by applying heat along a side seal 210 and along a terrace seal 208.

Jelly roll 202 also includes a set of conductive tabs 206 coupled to the cathode and the anode. Conductive tabs 206 may extend through terrace seal 208 (for example, formed using sealing tape 204) to provide terminals for battery cell 200. Conductive tabs 206 may then be used to electrically couple battery cell 200 with one or more other battery cells to form a battery pack. For example, the battery pack may be formed by coupling the battery cells in a series, parallel, or series-and-parallel configuration.

As mentioned above, battery cell 200 may accommodate the space constraints of a portable electronic device. As a result, the dimensions of battery cell 200 may accommodate the dimensions of the portable electronic device. For example, battery cell 200 may be more than 80-mm wide and 130-mm long but have a thickness of less than 3 mm to fit into a tablet computer and/or other device with a relatively thin form factor.

To facilitate efficient use of space within the portable electronic device, side seal 210 may be folded against battery cell 200. As a result, the dimensions of jelly roll 202 and/or battery cell 200 may be increased without occupying additional space in the portable electronic device. For example, the folding of a 2-mm-wide side seal 210 against battery cell 200 may allow the width of jelly roll 202 to be increased by 2 mm, thus increasing the energy density of battery cell 200.

However, the thinness of battery cell 200 may negatively impact the integrity of side seal 210 during folding of side seal 210. In particular, side seal 210 may be trimmed to less than the thickness of battery cell 200 before side seal 210 is folded against battery cell 200 to prevent side seal 210 from protruding past the thickness of battery cell 200 after the folding is complete. Because trimming of side seal 210 may increase the stiffness of side seal 210, folding of a narrow side seal 210 may subject side seal 210 to increased stress that causes cracking in the pouch and/or reduces the integrity of side seal 210. The reduced integrity may further result in leaking of electrolyte from battery cell 200, reaction of the electrolyte with moisture that enters battery cell 200, electrical contact between the electrolyte and the aluminum layer of the pouch, and/or failure of battery cell 200.

In one or more embodiments, the integrity of side seal 210 is maintained by increasing the temperature of side seal 210 during folding of side seal 210 against battery cell 200. More specifically, heat may be applied in the region of side seal 210 to produce a target temperature in the range of 55° C. to 75° C. at side seal 210 while side seal 210 is folded against battery cell 200. As discussed in further detail below, the heat may be applied prior to folding of side seal 210 and/or during folding of side seal 210. In turn, the heat may reduce stress on side seal 210 and enable a reduction in the thickness of battery cell 200 without compromising the integrity of side seal 210 and/or battery cell 200.

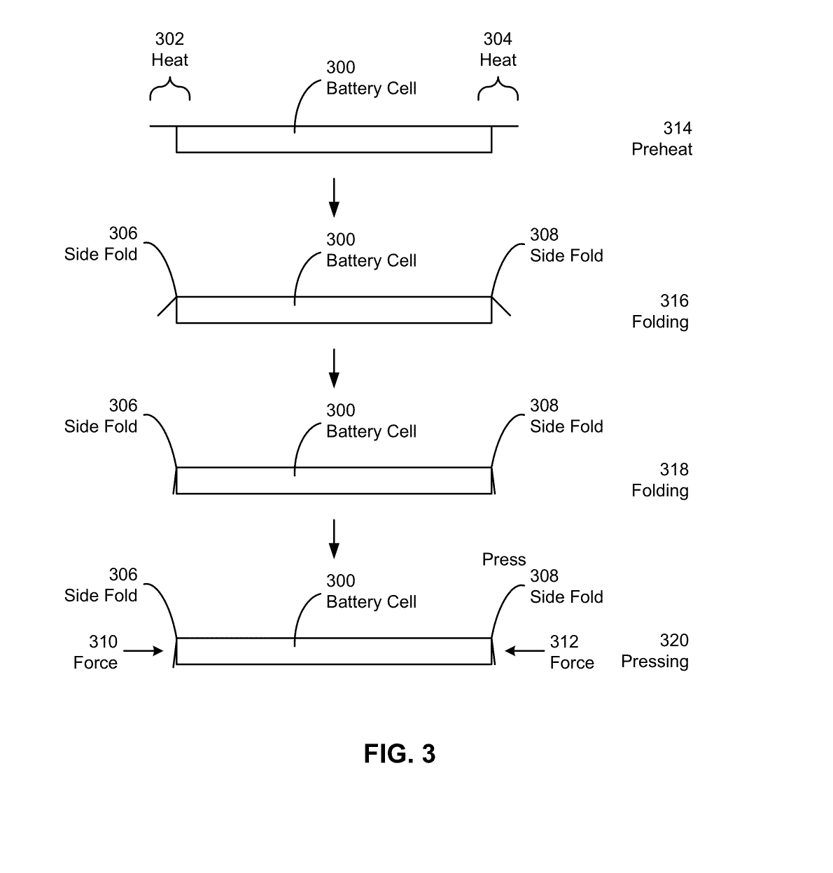

FIG. 3 shows an exemplary formation of a set of side folds 306-308 in a battery cell 300 in accordance with the disclosed embodiments. Initially, heat 302-304 is applied to battery cell 300 in the regions of a set of side seals in battery cell 300 during a preheat 314 stage. For example, heat 302-304 may be applied by resting battery cell 300 on a set of metal heaters for a period of 30 seconds to 90 seconds. While battery cell 300 is disposed over the metal heaters, the metal heaters may apply a temperature of about 110° C. to 150° C. to the regions of the side seals and/or the entirety of battery cell 300.

After application of heat 302-304 is complete, a set of side folds 306-308 may be formed in battery cell 300. As shown in FIG. 3, side folds 306-308 may be created over two stages, with a first folding 316 stage that creates a half bend in the side seals at about a 45° angle and a second folding 318 stage that creates a full bend in the side seals at about a 90° angle and places the side seals against battery cell 300. For example, side folds 306-308 may be created by applying downward force to the side seals while a set of blocks are placed along battery cell 300 underneath the side seals to form the angles in side folds 306-308. Alternatively, side folds 306-308 may be created by passing battery cell 300 through multiple sets of rollers. Folding 316-318 stages may be used to reduce stress on the side seals by progressively folding the side seals toward battery cell 300.

The application of heat 302-304 to battery cell 300 during preheat 314 may further reduce stress on the side seals by producing a target temperature in the range of 55° C. to 75° C. in the side seals during folding 316-318. For example, the side seals may have a temperature of 100° C. to 110° C. after preheat 314 is finished. The temperature of the side seals may then drop after heat 302-304 is removed, such that the side seals have a temperature of about 70° C. after folding 316 is complete and a temperature of about 62° C. after folding 318 is complete.

The target temperature may soften the side seals and prevent cracking in the side seals and/or pouch material for battery cell 300 that causes faults and/or failures in battery cell 300. Moreover, the temperature applied to the side seals during preheat 314 may be lower than the temperature used to form the side seals (e.g., 130° C. to 170° C.) to prevent the bonded polypropylene layers in the pouch material that form the side seals from separating and/or flowing.

Finally, force 310-312 is applied to the sides of battery cell 300 during a pressing 320 stage to set side folds 306-308. Heat may optionally be applied during pressing 320 to further set side folds 306-308.

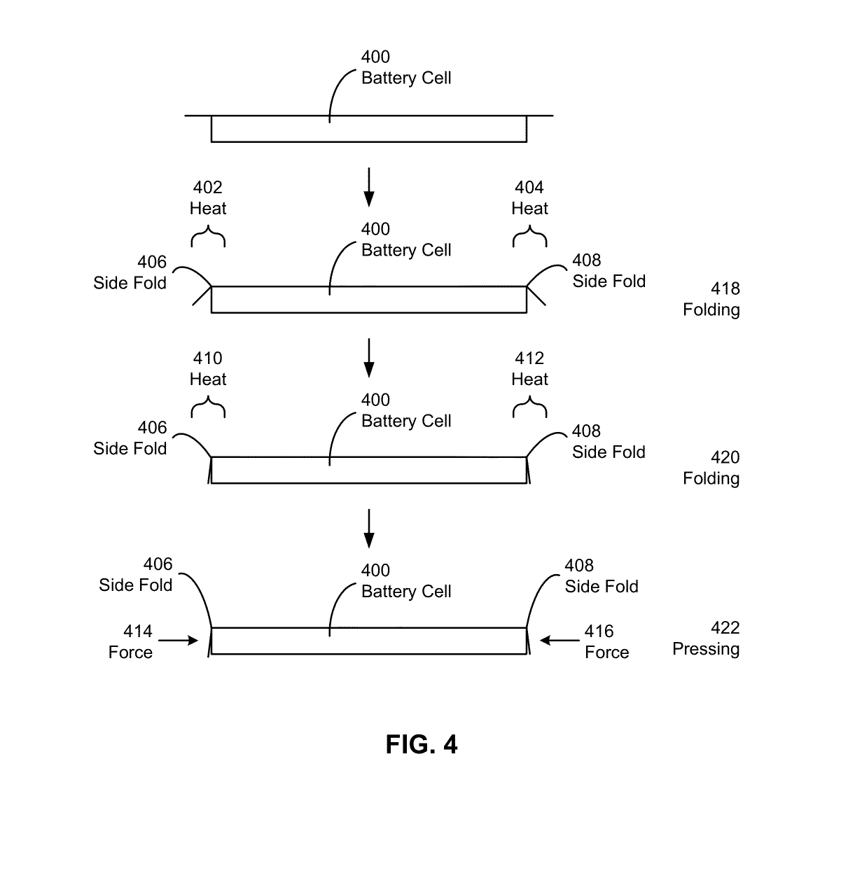

FIG. 4 shows an exemplary formation of a set of side folds 406-408 in a battery cell 400 in accordance with the disclosed embodiments. Unlike the formation of side folds 306-308 of FIG. 3, heat is not applied to battery cell 400 prior to folding of the side seals in battery cell 400. Instead, heat 402-404 and 410-412 may be applied during two folding 418-420 stages that create side folds 406-408 as half and full bends in the side seals, respectively.

As with preheating of battery cell 300 in FIG. 3, heat 402-404 and 410-412 may produce a target temperature in the range of 55° C. to 75° C. in the side seals during folding 418-420. For example, heat 402-404 and 410-412 may be applied to the side seals using one or more sets of folding guides (e.g., blocks, rollers, etc.) that facilitate the formation of the angles in side folds during folding 418-420.

To produce the target temperature, a temperature of about 120° C. to 130° C. may be applied to regions of the side seals during folding 418-420. For example, application of a temperature of 120° C. to the side seals may produce a temperature of about 48° C. to 59° C. in the side seals during folding 418 and a temperature of about 60° C. to 69° C. in the side seals during folding 420. Application of a temperature of 130° C. to the side seals may produce a temperature of about 52° C. to 65° C. during folding 418 and a temperature of about 66° C. to 77° C. during folding 420. As mentioned above, the target temperature may soften the side seals to reduce stress on the side seals during creation of side folds 406-408 without melting the bonded polypropylene layers forming the side seals.

After folding 418-420 of the side seals is complete, a pressing stage 422 is used to press the side seals against battery cell 400 and set side folds 406-408. During pressing 422, force 414-416 and/or additional heat may be applied to the sides of battery cell 400.

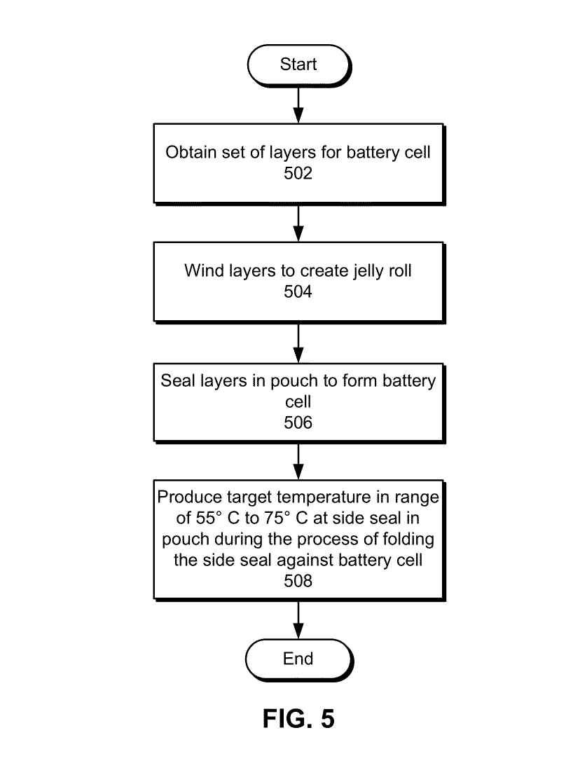

FIG. 5 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of layers for the battery cell is obtained (operation 502). The layers may include a cathode with an active coating, a separator, and an anode with an active coating. Next, the layers are wound to create a jelly roll (operation 504). The winding step may be skipped and/or altered if the layers are used to create other battery cell structures. For example, the layers may be stacked to create a bi-cell structure instead of wound to create the jelly roll.

The layers are then sealed in a pouch to form the battery cell (operation 506). For example, the battery cell may be formed by placing the layers into a pouch containing a layer of aluminum and a layer of propylene, filling the pouch with electrolyte, and forming side and terrace seals along the edges of the pouch. To form the side seal, the pouch may be heated to a temperature of 130° C. to 170° C. for a few seconds to bond the inner polypropylene layers of the pouch. The sealed area of the pouch may then be trimmed to less than the thickness of the battery cell to form the side seal.

After the layers are sealed in the pouch, a target temperature in the range of 55° C. to 75° C. is produced at a side seal in the pouch during folding of the side seal against the battery cell (operation 508). The side seal may then be folded by progressively folding the side seal toward the battery cell to form a side fold in the pouch and pressing the side seal against the battery cell to set the side fold. To produce the target temperature, a first temperature of about 110° C. to 150° C. may be applied to a region of the side seal in the battery cell prior to folding the side seal for 30 seconds to 90 seconds. Alternatively, a second temperature of about 120° C. to 130° C. may be applied to the region during folding of the side seal.

The target temperature may reduce stress on the side seal by softening the side seal. In turn, the reduced stress may avert cracking and/or loss of integrity caused by folding of a narrow, stiff side seal, thus enabling the creation of thinner battery cells with narrower side seals than conventional folding techniques that produce cracks in narrow side seals of battery cells. The reduced stress may further enable the creation of battery cells with increased thickness (e.g., greater than 8 mm) by preventing cracks in the battery cells' side folds that may be caused by the curvature of the side folds at the base of the battery cells.

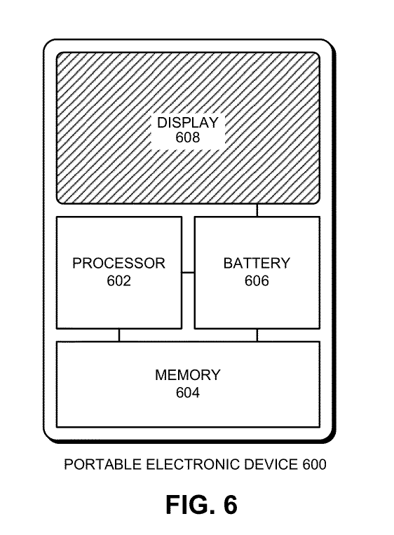

The above-described rechargeable battery cell can generally be used in any type of electronic device. For example, FIG. 6 illustrates a portable electronic device 600 which includes a processor 602, a memory 604 and a display 608, which are all powered by a battery 606. Portable electronic device 600 may correspond to a laptop computer, mobile phone, personal digital assistant (PDA), tablet computer, portable media player, digital camera, and/or other type of battery-powered electronic device. Battery 606 may correspond to a battery pack that includes one or more battery cells. Each battery cell may include a set of layers sealed in a pouch, including a cathode with an active coating, a separator, and/or an anode with an active coating.

During manufacturing of the battery cell, a side fold is formed in the pouch by producing a target temperature in the range of 55° C. to 75° C. at a side seal in the pouch during folding of the side seal against the battery cell. The target temperature may be produced by applying a first temperature of about 110° C. to 150° C. to a region of the side seal in the battery cell prior to folding the side seal and/or applying a second temperature of about 120° C. to 130° C. to the region during folding of the side seal. The target temperature may reduce stress on the side seal during creation of the side fold and enable a reduction in the thickness of the battery cell without compromising the integrity of the side seal.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for manufacturing a battery cell, comprising:
obtaining a set of layers for the battery cell, wherein the set of layers comprises a cathode with an active coating, a separator, and an anode with an active coating;
sealing the layers in a pouch to form the battery cell, wherein the pouch is flexible; and
producing a target temperature in the range of 55° C. to 75° C. at a side seal of the pouch during a process of folding the side seal against the battery cell.

2. The method of claim 1, further comprising:
coupling a first conductive tab to the cathode;
coupling a second conductive tab to the anode; and
extending the first and second conductive tabs through a terrace seal in the pouch to provide terminals for the battery cell.

3. The method of claim 1, further comprising:
stacking the layers prior to sealing the layers in the pouch.

4. The method of claim 1, further comprising:
winding the layers to create a jelly roll prior to sealing the layers in the pouch.

5. The method of claim 1, wherein producing the temperature at the side seal during the process of folding of the side seal against the battery cell involves at least one of:
applying a first temperature of about 110° C. to 150° C. to a region of the side seal in the battery cell prior to folding the side seal; and
applying a second temperature of about 120° C. to 130° C. to the region during folding of the side seal.

6. The method of claim 5, wherein the first temperature is applied for 30 seconds to 90 seconds prior to folding the side seal.

7. The method of claim 1, wherein the process of folding the side seal against the battery cell involves:
progressively folding the side seal toward the battery cell to form a side fold in the pouch; and
pressing the side seal against the battery cell to set the side fold.

8. The method of claim 1, wherein the target temperature reduces stress on the seal during folding of the side seal against the battery cell.

9. The method of claim 1, wherein the pouch comprises:
a layer of aluminum; and
a layer of polypropylene.

10. A battery cell, comprising:
a set of layers for the battery cell, wherein the set of layers comprises a cathode with an active coating, a separator, and an anode with an active coating; and
a pouch enclosing the layers, comprising:
a side seal; and
a terrace seal,
wherein a side fold is formed in the pouch by producing a target temperature in the range of 55° C. to 75° C. at the side seal during a process of folding the side seal against the battery cell.

11. The battery cell of claim 10, further comprising:
a first conductive tab coupled to the cathode; and
a second conductive tab coupled to the anode,
wherein the first and second conductive tabs extend through the terrace seal to provide terminals for the battery cell.

12. The battery cell of claim 10, wherein the set of layers are wound to create a jelly roll or stacked.

13. The battery cell of claim 10, wherein producing the temperature at the side seal during the process of folding the side seal against the battery cell involves at least one of:
applying a first temperature of about 110° C. to 150° C. to a region of the side seal in the battery cell prior to folding the side seal; and
applying a second temperature of about 120° C. to 130° C. to the region during folding of the side seal.

14. The battery cell of claim 13, wherein the first temperature is applied for 30 seconds to 90 seconds prior to folding the side seal.

15. The battery cell of claim 10, wherein the process of folding the side seal against the battery cell involves:
progressively folding the side seal toward the battery cell to form the side fold; and
pressing the side seal against the battery cell to set the side fold.

16. The battery cell of claim 10, wherein the target temperature reduces stress on the seal during folding of the side seal against the battery cell.

17. The battery cell of claim 10, wherein the pouch comprises:
a layer of aluminum; and
a layer of polypropylene.

18. A portable electronic device, comprising:
a set of components powered by a battery pack; and
the battery pack, comprising:
a battery cell, comprising:
a set of layers comprising a cathode with an active coating,
a separator, and an anode with an active coating; and
a pouch enclosing the layers, comprising:
a side seal; and
a terrace seal,
wherein a side fold is formed in the pouch by producing a target temperature in the range of 55° C. to 75° C. at the side seal during a process of folding the side seal against the battery cell.

19. The portable electronic device of claim 18, wherein the battery cell further comprises:
a first conductive tab coupled to the cathode; and
a second conductive tab coupled to the anode,
wherein the first and second conductive tabs extend through the terrace seal to provide terminals for the battery cell.

20. The portable electronic device of claim 18, wherein the set of layers are wound to create a jelly roll or stacked.

21. The portable electronic device of claim 18, wherein producing the temperature at the side seal during the process of folding the side seal against the battery cell involves at least one of:
applying a first temperature of about 110° C. to 150° C. to a region of the side seal in the battery cell prior to folding the side seal; and
applying a second temperature of about 120° C. to 130° C. to the region during folding of the side seal.

22. The portable electronic device of claim 21, wherein the first temperature is applied for 30 seconds to 90 seconds prior to folding the side seal.

23. The portable electronic device of claim 18, wherein the process of folding the side seal against the battery cell involves:
progressively folding the side seal toward the battery cell to form the side fold; and
pressing the side seal against the battery cell to set the side fold.

24. The portable electronic device of claim 18, wherein the target temperature reduces stress on the seal during folding of the side seal against the battery cell.

25. The portable electronic device of claim 18, wherein the pouch comprises:
a layer of aluminum; and
a layer of polypropylene.
